(19) United States
(12) Patent Application Publication
(10) Pub. No.: US 2014/0278527 A1
(43) Pub. Date: Sep. 18, 2014

(54) LARGE SCALE IDENTIFICATION AND ANALYSIS OF POPULATION HEALTH RISKS

(71) Applicant: CERNER INNOVATION, INC, Lenexa, KS (US)

(72) Inventor: RYAN ALAN BRUSH, OVERLAND PARK, KS (US)

(73) Assignee: CERNER INNOVATION, INC., LENEXA, KS (US)

(21) Appl. No.: 13/803,459

(22) Filed: Mar. 14, 2013

(51) Int. Cl. G06F 19/00; G06Q 50/24

(52) U.S. Cl. CPC G06F 19/3431; G06Q 50/24
USPC 705/3

(57) ABSTRACT

Methods, systems, and computer-storage media are provided for facilitating the management of population health. A parallel processing architecture receives patient population health data from healthcare facilities along with any updated data. A high-level clinical logic is executed against the data to identify, among other things, patients in the population who qualify for health intervention programs. Using this information, healthcare facilities can implement management programs to help care for these patients.

### BACKGROUND

Healthcare facilities are taking on increasing responsibility for managing the overall health of population segments serviced by the facilities. This is partly in response to insurance payment models that provide for additional payments to the healthcare facilities when certain segments within the population meet qualifying criteria. For example, additional payments may be made to the healthcare facilities when patients within an identified diabetic population segment have blood glucose values and other lab results within a predefined range.

Traditional systems are ill-adapted to meet the requirements of population health management. For example, traditional systems are often unnecessarily complex and inflexible. They are unable to meet emerging needs or to scale to meet the demands associated with processing the large volumes of health data associated with the population segments. For example, a population segment associated with a healthcare facility may encompass up to 2,000,000 or more patients. Very few healthcare facilities have the processing power to effectively manage population segments this large. As well, current processing logic used in population health management is often tied to specific data formats or structures, and lacks the extensibility to be executed against data in varying formats.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief, and at a high level, the present invention is directed to methods, systems, and computer-storage media for enabling a healthcare facility to manage the health of population segments. Management may include identifying members of a population who qualify for health intervention programs, stratifying identified members based on degree of risk, and monitoring ongoing health data for the identified members to determine the effectiveness of the program. Patient population health data is received and stored in association with a distributed storage system. Parallel processors coupled to the storage system execute simple, descriptive clinical logic against the population data to identify members who qualify for the health intervention programs. The same logic is used to process any updated data as it enters the system. Clinical logic is further utilized to stratify the members based on degree of risk and to monitor the ongoing health of the members.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is a block diagram showing an exemplary architecture for facilitating the aggregation and processing of patient population health data suitable to implement embodiments of the present invention;

FIG. 3 is a block diagram of an exemplary system for, among other things, identifying members of a population who qualify for one or more health intervention programs suitable to implement embodiments of the present invention;

FIG. 4 is a flow diagram of an exemplary method of utilizing patient population health data to identify members of a population who qualify for one or more health intervention programs in accordance with an embodiment of the present invention;

FIG. 5 is a flow diagram of an exemplary method of utilizing population health data including any updates to the data to identify members of a population who qualify for one or more health intervention programs in accordance with an embodiment of the present invention; and

FIG. 6 depicts a visual representation of high-level clinical logic in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The present invention is directed to methods, systems, and computer-storage media for enabling a healthcare facility to manage the health of population segments. Management may include identifying members of a population who qualify for health intervention programs, stratifying identified members based on degree of risk, providing condition-specific recommendations, and monitoring ongoing health data for the identified members to determine the effectiveness of intervention strategies. Patient population health data is received and stored in association with a distributed storage system. Parallel processors coupled to the storage system execute simple, descriptive clinical logic against the population data to identify members who qualify for the health intervention programs. The same logic is used to process any updated data as it enters the system. Clinical logic is further utilized to stratify the members based on degree of risk, determine condition-specific recommendations, monitor the ongoing health of the members, and the like.

Having provided a high-level overview of the present invention, an exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of non-transitory computer-readable media. Computer-readable media can be any available media that might be accessed by control server 102, and includes volatile and nonvolatile media, as well as, removable and nonremovable media. By way of example, and not limitation, computer-readable media may comprise non-transitory computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and providers' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information may also be entered via use of gestures such as tapping, swiping, dragging, pinching, and the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

Turning now to FIG. 2, a block diagram 200 is illustrated, in accordance with an embodiment of the present invention, showing an exemplary cloud computing platform 224 for use by a population health analysis system 210. It will be understood and appreciated that the cloud computing platform 224 shown in FIG. 2 is merely an example of one suitable computing system environment and is not intended to suggest any limitation as to the scope of use or functionality of embodiments of the present invention. For instance, the cloud computing platform 224 may be a public cloud, a private cloud, or a dedicated cloud. Neither should the cloud computing platform 224 be interpreted as having any dependency or requirement related to any single component or combination of components illustrated therein. Further, although the various blocks of FIG. 2 are shown with lines for the sake of clarity, in reality, delineating various components is not so clear, and metaphorically, the lines would more accurately be grey and fuzzy. In addition, any number of physical machines, virtual machines, data centers, endpoints, or combinations thereof may be employed to achieve the desired functionality within the scope of embodiments of the present invention. As mentioned, the cloud computing platform 224 comprises a cloud-computing network, which is known in the art as “the cloud.”

The cloud computing platform 224 includes a data center configured to host and support the operation of the system 210. The system 210 refers to any software, or portions of software, that runs on top of, or accesses storage locations within, the platform 224. It will be appreciated that cloud computing platform 224 may include multiple computing devices such as computing devices or portions of computing devices 100 shown in FIG. 1. Cloud computing platform 224 may include virtual machines, such as software, applications, operating systems, or programs that are executed by a processing unit to underlie the functionality of the population health analysis system 210. Further, the virtual machines may include processing capacity, storage locations, and other assets to support the population health analysis system 210.

In one aspect, the cloud computing platform 224 can communicate internally through connections dynamically made between the virtual machines and computing devices and externally through a physical network topology to resources of a remote network such as with healthcare facilities 212, 216, and 220. By way of example, the connections may include, without limitation, one or more local area networks (LANs) and/or wide area networks (WANs). Such networking environments are commonplace in offices, enterprise-wide computer networks, intranets, and the Internet. Accordingly, the network is not further described herein.

As shown in FIG. 2, the population health analysis system 210 is capable of communicating with a number of different data sources, such as the healthcare facilities 212, 216, and 220 for the collection of patient population health data. Other exemplary data sources may include raw claims data, continuity of care documents (CCDs), and the like. As used throughout this application, the term “patient population health data” is meant to be broad and encompass many types of healthcare information found in a healthcare environment. For example, patient population health data may include information that describes various aspects of the patient state, including patient vitals, lab results, medication orders, diagnosis codes, condition codes, clinical orders, indexed values from clinical notes or other text documents, patient demographic information, patient history, patient images, and a variety of other patient information.

The healthcare facilities 212, 216, and 220 may include, for example, hospitals, physician offices, health information exchanges, nursing homes, pharmacies, home health services, urgent care clinics, and the like. The healthcare facilities 212, 216, and 220 may develop intervention programs designed to reduce the morbidity and mortality associated with certain widespread health problems such as hypertension, diabetes, smoking, and obesity. The intervention programs utilize a multi-disciplinary team consisting of health coaches, physicians, dieticians, pharmacists, etc. to care for patients who are enrolled in the program. Identification of patients who qualify for enrollment in these programs is important in ensuring the program's success.

In one aspect, the healthcare facilities 212, 216, and 220 may be part of a larger healthcare organization. As used throughout this application, a healthcare organization may comprise a single healthcare facility with an associated group of healthcare providers such as physicians, pharmacists, nurses, health coaches, therapists, and the like. A healthcare organization may also comprise a network of healthcare facilities such as the healthcare facilities 212, 216, and 220, each healthcare facility having an associated group of healthcare providers. The healthcare organization may create such networks in order to achieve certain financial and/or clinical objectives. For example, the healthcare organization may create such a network in order to manage the health of a population segment.

It should be noted that the healthcare facilities shown as communicating with the population health analysis system 210 in FIG. 2 are provided by way of example only and are not intended to limit the scope of the present invention in any way. Each healthcare facility 212, 216, and 220 may have one or more computing devices such as computing device 100 of FIG. 1, for communicating with the population health analysis system 210. Each healthcare facility 212, 216, and 220 maintains its own native electronic medical record system represented by a native data store (1) 214, a native data store (2) 218, and a native data store (3) 222 associated with the first, second, and third healthcare facilities respectively. Further, the healthcare facilities 212, 216, and 220 may not be directly or indirectly connected with one another such that the native data stores 214, 218, and 222 are utilized only by the data stores' respective healthcare facility. The healthcare facilities 212, 216, and 220 send information to the cloud computing platform 224 and not typically directly between one another. In addition, communication between the system 210 and the various healthcare facilities 212, 216, and 220 may be via one or more networks, which may comprise one or more wide area networks (WANs) and one or more local area networks (LANs), as well as one or more public networks, such as the Internet, and one or more private networks.

Further, the healthcare facilities 212, 216, and 220 may be able to access the system 210 in a variety of ways within the scope of the present invention. For example, in some embodiments, a healthcare facility may have a native clinical computing system, which may be able to communicate with the system 210. In other embodiments, a client application associated with the system 210 may reside or partially reside on one or more of the healthcare facility's computing devices facilitating communication with the system 210. In further embodiments, communication may simply be a web-based communication, using, for example, a web browser to communicate to the system 210 via the Internet. Any and all such variations are contemplated to be within the scope of embodiments of the present invention.

The population health analysis system 210 is available in the cloud computing platform 224 in a manner that enables cross-venue recognition of a patient through the use of a patient identity management component 226 such as an Electronic Master Person Index (EMPI). Patient identity management component 226 enables the system 210 to match data for the same patient that originates from different healthcare facilities or sources. Processing elements of a runtime engine 228 receive patient population health data that is sent to the cloud platform 224 by the healthcare facilities 212, 216, and 220 and use this information, among other things, to identify members of the population that qualify for one or more health intervention programs. This information may be used, in turn, by the healthcare facilities 212, 216, and 220 (or by a healthcare organization composed of the healthcare facilities 212, 216, and 220) to manage the health of population segments for which the healthcare facilities 212, 216, and 220 provide care.

FIG. 3 depicts a more detailed view of the runtime engine 228 of FIG. 2 (now labeled as runtime engine 309 in system 300). The runtime engine 309 includes a plurality of batch processing nodes 310, 312, 314, and 316, a plurality of incremental processing nodes 324, 326, 328, and 330, and outcome data 340 stored in an outcome data store 340. Although a plurality of batch processing nodes and a plurality of incremental processing nodes are shown, the following discussion will generally reference only the batch processing node 310 and the incremental processing node 324. However, the discussion with respect to these nodes is equally applicable to the remaining batch processing nodes 312, 314, and 316, and the remaining incremental processing nodes 326, 328, and 330.

FIG. 3 includes data sources 342, 344, and 346. The data sources 342, 344, and 346 may include native data stores associated with one or more healthcare facilities such as the native data stores 214, 218, and 222 of FIG. 2. As well, the data sources 342, 344, and 346 may include raw claims data, CCD, and the like. The data sources 342, 344, and 346 store information including patient records, such as electronic medical records (EMRs) for patients that make up one or more patient population segments

The patient information stored in association with the data sources 342, 344, and 346 is received by the runtime engine 309 by one of several methods. For instance, the runtime engine 309 may include, in one aspect, a program that synchronizes data from the data sources 342, 344, and 346 to the runtime engine 309 (hereinafter known as the “synchronization process”). The synchronization process extracts relevant information for a particular patient from the patient's EMR. The information may include a complete historical record of a patient's EMR. The information extracted by the synchronization process may also include any updates or modifications to the patient's EMR. Updates are received by the runtime engine 309 substantially simultaneously with when the information is updated in the patient's EMR. In another aspect, the runtime engine 309 may query the data sources 342, 344, and 346 to obtain patient information. Using these methods, for example, the runtime engine 309 receives patient population health data for a multitude of patients.

The collected patient population health data may be received in any number of structures or formats. For example, health data may be received from one data source in a relational format but be received by another data source in a hierarchical format. Further, the health data received from both of these data sources may be directed to a single piece of data such as, for example, a blood glucose level. Thus, blood glucose levels may be received in multiple different formats depending upon the characteristics of the EMR system from which they were received. Additional structures or formats include HL7 feeds, Continuity of Care Documents (CCDs), and electronic data interchange (EDI) files containing medical claims information.

The raw patient population health data may be converted into one or more standardized structures prior to being stored in a distributed storage system associated with the plurality of batch processing nodes 310, 312, 314, and 316. Additionally, the now-standardized data may be mapped or grouped into certain high-level concepts prior to being stored in the distributed storage system.

Concept mapping and/or concept grouping may be defined as converting the raw data received from the data sources 342, 344, and 346, into high-level, domain-specific constructs using a system logic. For example, a piece of raw data that describes a condition may be converted into a clinically-useful fact that a given patient has, for example, Diabetes. The system logic (e.g., system.clj) is employed to convert the raw data into one or more high-level constructs. An example of the system logic is provided below in Example 1:

### Example 1

;;; Set the concept library to be used for this program.
(concept-context<CONCEPT-SYSTEM-IDENTIFIER>)
(defrule standard_diabetic_condition
(clinical-newest from Condition (and (has-concept? conditionCode “DIABETES”) (has-concept? classification “DISCHARGE”)))
→(insert DiabetesCondition)

The “concept-context” line shows a unique identifier of the concept grouping content being used.

The batch processing node 310 of the runtime engine 309 includes a processor 318 executing a high-level clinic logic 320 and distributed storage 322. The distributed storage 322 stores the patient population health data after standardization and concept mapping/grouping. In one aspect, the distributed storage 322 maintains a complete historical electronic medical record for one or more patients associated with the batch processing node 310.

The use of storage systems associated with each of the batch processing nodes 310, 312, 314, and 316 is important in supporting the large amounts of data associated with population health (e.g., petabyte-scale data sets). As well, using distributed storage systems eliminates the need to send existing data over networks or consume external resources. The distributed storage 322 stores all clinical information relating to a patient instead of spreading the patient's information across multiple processing nodes. This facilitates accessing and processing the information at substantially the same time.

The processor 318 executes the high-level clinical logic 320 against the patient population health data stored in association with the distributed storage 322 in order to, among other things, identify members of the population that qualify for health intervention programs such as a hypertension management program or a diabetes management program. The high-level clinical logic 320 may also be used to stratify identified members based on degree of risk, provide condition-specific recommendations, and monitor the ongoing health of identified members. The logic 320 is a healthcare-domain-specific clinical logic that takes the high-level constructs generated by the system logic (e.g., Example 1 above) and generates clinically-useful results. The logic 320 has several characteristics. First, it is a declarative, descriptive language which, rather than defining actions based on traditional “if-this-then-that” logic, simply describes the set of data that is of interest using high-level concepts. For example, sample code that executes on the high-level construct DiabetesCondition generated above in Example 1 may include:

### Example 2

(defrule hba1c_less_than_{—}7_met
(DiabetesCondtion [identified==true])
(LeastHba1cResult [clinical-value (this)<7])
→(insert Hba1cLessThan7 “ME” “Display Text”))

In another example, the logic 320 may be used to identify patients who qualify for a hypertension management program:

### Example 3

(defrule in_population
“Determine if the person is in the population”
(demographics [age>18 and age<76])
(Diagnosis [type=:hypertension])
(Encounter [type=:inpatient])
→(insert InHypertensionPopulation))

As seen in Example 3, the logic 320 simply declares the conditions under which the patient is considered to be part of the hypertensive population. That fact is then inserted into the working knowledge for that patient and may be leveraged by other declarative actions. The logic 320 can also be utilized to declare new concepts. For example, a concept regarding diastolic blood pressure may be defined as follows in Example 2:

### Example 4

(defconcept DiastolicBP
from ClinicalResult
where type_cd in diastolic_bp_nomenclature))

Downstream logic can then leverage the presence of this concept rather than deal with the complexity of the underlying clinical models. For example, the statement that follows determines if the patient has high diastolic blood pressure and inserts that into the working knowledge of the patient:

### Example 5

(defrule high_diastolic_bp
(DiastolicBP [value>90 and value<100])→(insert HighDiastolicBP))

Because the logic 320 is declarative and defers to the runtime engine 309 to provide its data, it can be executed across an arbitrary number of processors with linear scalability. This means that a set of rules can be defined once and executed in a large cluster of processing nodes without having to move data resulting in the ability to analyze very large populations significantly faster than was previously possible. For example, health data associated with approximately 2,000,000 patients can be processed by eight batch processing nodes in less than 15 minutes in order to identify and classify patients within this segment into hypertension and diabetes management programs.

Second, and as shown above, the logic 320 is structured to enable code in high-level clinical language by leveraging the use of concept mapping and/or concept grouping. As explained above, concept mapping and/or concept grouping are techniques where low-level identifiers are translated into high-level concepts with simple semantics. Thus, instead of logic that acts on numeric codes or concept identifiers, the logic 320 can act on first-class concepts. For example, traditional logic may act on code value XYZ in SNOMED, while the logic 320 can execute against a higher-level concept defined by concept grouping system logic such as, for example, “SystolicBloodPressure.”

Third, the logic 320 views code as data meaning that the code in the logic 320 is actually a data structure that can be read, explored, and manipulated like other data structures. The logic 320 also provides facilities for exploring these data structures by visually rendering the data structures on a graphical user interface. The visual representations are rendered directly from the logic's data structure without any additional metadata. This feature enables interactive interfaces where a user can edit the logic 320 visually by adding, removing, and editing descriptions in each box of the visual representation. The logic 320 is also searchable to find specific pathways. This feature is important for trouble-shooting problems and/or for implicitly creating audit trails. Contrast this with traditional logic where programmers must often explicitly bookmark certain pieces of data that are later used to create an audit trail. Because the logic 320 employs high-level clinical language, logic editors can include clinicians with no working knowledge of computer programming.

FIG. 6 depicts a visual representation of the logic that generally follows Examples 3, 4 and 5 and is referenced generally by the numeral 600. FIG. 6 includes a set of concepts 610, 612, and 614 that may be generated using, for example, concept grouping system logic as described above with respect to, for example, Example 1. Arrows 616, 618, and 619 indicate a set of rules applied respectively to the concept 610, the concept 612, and the concept 614 to generate a first set of results 620, 622, and 624. Additional rules 626, 628, and 630 may be applied to the results 620, 622, and 624 to define additional concepts. For example, high systolic blood pressure and high diastolic blood pressure are grouped together to generate the concept “High Blood Pressure” 634. On the other hand, the result 624 “Exclude_pregnancy” is linked to the “Excluded” concept 636. A new concept, “Person,” 632 is brought in at this point. Rules 638, 640, and 642 are applied to the concepts 632, 634, and 636 to define a hypertensive patient population segment, “Is_Hypertensive” 644, which, in turn, can be linked to the concept “IsHypertensive” 646. The concept “IsHypertensive” 646 may be further utilized by downstream logic.

As seen in the visual representation 600, references to specific clinical logic lines are shown thereby creating an implicit audit trail that enables the logic editor to easily follow the flow of the logic 320 in order to determine why a particular patient was included within the hypertension population segment. As well, references to specific clinical logic lines are useful for troubleshooting errors. The visual representation 600 is editable and searchable enabling the logic editor to edit, find, delete or add information.

Returning to FIG. 3, the output of the batch processing nodes 310, 312, 314, and 316 is outcome data 340 stored in the outcome data store 340. Depending on the logic 320 executed, the outcome data 340 may include members of a population identified to be eligible for one or more health intervention programs, a stratification of the identified members based on degree of risk, condition-specific recommendations, and data related to monitoring the health of identified members to determine if the members' health is stable, declining, or improving while enrolled in the program(s). The outcome data 340 may be available to healthcare facilities, such as the healthcare facilities 212, 216, and 220 of FIG. 2, to assist those facilities in managing the health of the population segments serviced by the facilities. As well, the outcome data 340 may be used for analytics, patient registries, and the like.

As mentioned, the runtime engine 309 further includes the incremental processing nodes 324, 326, 328, and 330 of which the incremental processing node 324 will be used as a representative example. The incremental processing node 324 includes a processor 332 executing high-level clinical logic 334, and a memory cache 336. The logic 334 is the same as the logic 320 used by the batch processing node 318. The incremental processing node 324 generally subscribes to health data updates associated with one or more specified patients. Updates are streamed in real time to the incremental processing node 324 via the synchronization process as the updates occur. Once an update is received, the incremental processing node 324 processes the update using the logic 334.

The cache 336 stores portions of a patient's electronic medical record that are pertinent to the execution of the logic 334. The cache 336 may be emptied if no active updates for the patient are received and/or if the incremental processing node 324 is running low on memory. If an update is subsequently received for the patient, the pertinent portions of the patient's electronic medical record are re-loaded from the distributed storage 322 as shown by arrow 338.

Outcome data 340 is generated by the incremental processing nodes 324, 326, 328, and 330. Like above, the outcome data 340 may include members of a patient population who qualify for one or more health intervention programs, a stratification by degree of risk of the identified members, condition-specific recommendations, and monitoring data related to the identified members.

Although use of the high-level clinical logic has been discussed in terms of a parallel processing architecture, it is contemplated that the high-level clinical logic may also be utilized in simple service calls relating to a single patient. For example, an application may be configured to receive a clinician request directed towards determining if a certain patient qualifies for enrollment in a hypertension program. The application can execute the high-level clinical logic against the patient's data to determine if the patient qualifies for the program. Any and all such aspects, and any combination thereof, are contemplated as being within the scope of the invention.

Turning now to FIG. 4, a flow diagram is shown of an exemplary method 400 of identifying members of a population who qualify for health intervention programs. Types of intervention programs are numerous, but representative examples may include hypertension management programs and diabetes management programs. At a step 410, patient population health data is received by a runtime engine (such as the runtime engine 309 of FIG. 3) from one or more data sources, such as the healthcare facilities 212, 216, and 220 of FIG. 2. Prior to being received from the healthcare facilities, the patient population health data is generally stored in association with electronic medical record systems associated with the healthcare facilities and includes such information as lab results, clinical notes, procedure results, medication orders, peripheral device readings, and the like for patients serviced by the healthcare facilities. The patient population health data may be received in multiple, disparate formats depending on the underlying characteristics of the electronic medical record systems that store the information.

At a step 412, the received patient population health data is stored in association with a distributed storage system such as the distributed storage 322 of FIG. 3. As explained above, the storage is distributed across a plurality of batch processing nodes, and each storage system generally stores a complete, historical electronic medical record of one or more specified patients. In one aspect, prior to storing the data in the distributed storage system, the data is minimally processed to convert the raw data into standardized structures which are further translated into high-level concepts using concept mapping and concept grouping system logic.

At a step 414, batch processing nodes, such as the batch processing nodes 310, 312, 314, and 316 of FIG. 3, execute a high-level clinical logic against the patient population health data in order to identify members of the population who qualify for one or more health intervention programs. For example, high-level clinical logic may be used to identify members of the population who are at risk for or qualify for a hypertension management program administered by a healthcare facility. Additional high-level clinical logic may be used to stratify members within the identified segment based on degree of risk, or to monitor health metrics of identified members in order to determine if the management program is effective.

As explained above, the high-level clinical logic is a healthcare-domain specific declarative language that utilizes high-level concepts to describe data of interest. The high-level clinical logic operates independently of the underlying data format allowing it to be de-coupled from existing data formats and pushed out to multiple processing nodes acting in parallel in order to process large amounts of data. Further, because the logic views code as data, the logic can be visually represented on a graphical user interface. A user, such as a clinician, is able to edit the logic on the user interface. For instance, the user can add, remove, and edit logic descriptions. The logic is also searchable so that the user can find specific pathways. Further, branches may be collapsed and hidden from view to simplify searching. A natural consequence of this logic feature is that the visual representation implicitly depicts an audit trail which may be useful for trouble-shooting or determining why a particular patient was included within a particular program.

Turning to FIG. 5, FIG. 5 depicts a flow diagram of an exemplary method 500 of managing population health. At a step 510, patient population health data is received from one or more electronic medical records systems associated with one or more healthcare facilities. At a step 512, the patient population health data is stored in association with a distributed storage system that is physically coupled to a plurality of batch processing nodes acting in parallel.

At a step 514, updates to the patient population health data are received by one or more incremental processing nodes, such as the incremental processing nodes 324, 326, 328, and 330 of FIG. 3, of a runtime engine. Each incremental processing node subscribes to updates relating to one or more specified patients. Further, each incremental processing node maintains a memory cache. Patient information that facilitates execution of the high-level clinical logic (e.g., provides context to the clinical logic) is maintained in the memory cache. If no recent updates are received for a patient and/or if memory is running low on the incremental processing node, the memory cache may be dumped. If, however, new data is received for the patient, the cache may be re-loaded from the distributed storage system associated with the batch processing nodes.

At a step 516, a high-level clinical logic is executed against the patient population health data and the updated information to, among other things, identify members of a population who qualify for one or more health intervention programs. Each batch processing node and each incremental processing node has an associated processor (e.g., the processor 318 and the processor 332 respectively of FIG. 3) that executes the high-level clinical logic. Other outcome data resulting from the execution of the logic may include stratification data based on degree of risk, and monitoring data.

The present invention has been described in relation to particular embodiments, which are intended in all respects to be illustrative rather than restrictive. Further, the present invention is not limited to these embodiments, but variations and modifications may be made without departing from the scope of the present invention.

What is claimed is:

1. One or more computer-storage media having computer-executable instructions embodied thereon that, when executed by a computing device, facilitate a method of identifying members of a population who qualify for one or more health intervention programs, the method comprising:
receiving one or more sets of patient population health data;
storing the one or more sets of patient population health data in association with a distributed storage system; and
executing a first set of high-level clinical logic against the one or more sets of patient population health data to identify one or more members of the population who qualify for the one or more health intervention programs.

2. The media of claim 1, wherein the one or more sets of patient population health data are received from electronic medical record systems associated with one or more healthcare facilities.

3. The media of claim 2, wherein the one or more sets of patient population health data are received in disparate formats.

4. The media of claim 1, wherein prior to storing the one or more sets of population health data in association with the distributed storage system, the one or more sets of population health data are minimally processed using concept mapping and concept grouping.

5. The media of claim 1, wherein the first set of high-level clinical logic is a declarative language such that high-level concepts are utilized to describe a subset of patient population health data within the one or more sets of patient population health data that is of interest.

6. The media of claim 5, wherein the first set of high-level clinical logic is healthcare-domain specific.

7. The media of claim 5, wherein execution of the first set of high-level clinical logic is independent of the underlying data format associated with the one or more sets of patient population health data.

8. The media of claim 1, wherein the first set of high-level clinical logic is further utilized to render a visual representation of the high-level clinical logic on a user interface.

9. The media of claim 8, wherein the visual representation implicitly defines an audit trail.

10. The media of claim 1, further comprising executing a second set of high-level clinical logic against the one or more sets of patient population health data to stratify the one or more members of the population based on degree of risk.

11. The media of claim 10, further comprising executing a third set of high-level clinical logic against the one or more sets of patient population health data to monitor health data related to the one or more members of the population who qualify for the one or more health intervention programs.

12. A computer-implemented system for processing and updating population health data, the system comprising:
a runtime engine comprising:
a plurality of batch processing nodes operable to:
(A) receive one or more sets of patient population health data,
(B) store the one or more sets of patient population health data in association with a distributed storage system, and
(C) execute a high-level clinical logic against the one or more sets of patient population health data to identify a first set of members of the population who qualify for one or more health intervention programs; and
a plurality of incremental processing nodes operable to:
(A) receive updates to the one or more sets of patient population health data, and
(B) execute the high-level clinical logic against the updates to identify a second set of members of the population who qualify for the one or more health intervention programs.

13. The system of claim 12, wherein the one or more sets of patient population health data and the updates to the one or more sets of patient population health data are received from healthcare facilities located remote to the plurality of processing nodes and the plurality of incremental processing nodes.

14. The system of claim 12, wherein the distributed storage system is physically located in association with the plurality of batch processing nodes.

15. The system of claim 12, wherein the updates to the one or more sets of patient population health data are received in real time.

16. The system of claim 12, wherein a memory cache is associated with each incremental processing node of the plurality of incremental processing nodes.

17. The system of claim 16, wherein the memory cache stores a subset of the one or more sets of patient population health data pertinent to the execution of the high-level clinical logic.

18. One or more computer-storage media having computer-executable instructions embodied thereon that, when executed by a computing device, facilitate of method of managing population health, the method comprising:
receiving one or more sets of patient population health data from one or more electronic medical record systems;
storing the one or more sets of patient population health data in association with a distributed storage system;
receiving one or more sets of updated patient population health data from the one or more electronic medical record systems; and
executing a high-level clinical logic against the one or more sets of patient population health data and the one or more sets of updated patient population health data to identify one or more members of the population at risk who qualify for one or more health intervention programs.

19. The media of claim 18, wherein the one or more electronic medical record systems are associated with one or more healthcare facilities

20. The media of claim 18, wherein the one or more electronic medical record systems store the one or more sets of patient population health data in disparate formats.
